(19) United States
(12) Patent Application Publication
(10) Pub. No.: US 2013/0272259 A1
(43) Pub. Date: Oct. 17, 2013

(54) METHOD AND APPARATUS FOR ALLOCATING A COMPONENT CARRIER IN A CARRIER JUNCTION SYSTEM

(71) Applicants: Soyeon Kim, Anyang-si (KR); Jinmin Kim, Anyang-si (KR); Seunghee Han, Anyang-si (KR)

(72) Inventors: Soyeon Kim, Anyang-si (KR); Jinmin Kim, Anyang-si (KR); Seunghee Han, Anyang-si (KR)

(73) Assignee: LG ELECTRONICS INC., Seoul (KR)

(21) Appl. No.: 13/995,832

(22) PCT Filed: May 7, 2011
(86) PCT No.: PCT/KR2011/003417

§ 371 Date: Jun. 19, 2013

Related U.S. Application Data
(60) Provisional application No. 61/424,682, filed on Dec. 20, 2010.

(51) Int. Cl. H04W 72/04

(52) U.S. Cl. CPC H04W 72/042
USPC 370/329

(57) ABSTRACT

The present invention relates to a carrier junction system. Concretely, the present invention relates to a method for allocating a component carrier in a carrier junction system, the method being characterized by comprising a step of receiving at least one item of component carrier configuration information supported by a base station, from the base station, wherein the component carrier configuration information includes at least one item of component carrier set information, and said at least one item of component carrier set information is downlink component carrier set information transmitted by a physical downlink shared channel (PDSCH), uplink component carrier set information transmitted by a physical uplink shared channel (PUSCH), or PDSCH monitoring component carrier set information transmitted by a physical downlink control channel (PDCCH).

### TECHNICAL FIELD

The present invention relates to a carrier aggregation system and more specifically, to a method and apparatus for allocating component carriers supported by a base station.

### BACKGROUND ART

3GPP LTE (3^{rd} Generation Partnership Project Long Term Evolution, referred to as ‘LTE’ hereinafter) and LTE-Advanced (referred to as ‘LTE-A’ hereinafter) systems are described as an example of a mobile communication system to which the present invention is applicable.

One or more cells are present per base station. A cell sets one of bandwidths of 1.25 MHz, 2.5 MHz, 5 MHz, 10 MHz, 15 MHz and 20 MHz for a carrier and provides downlink/uplink transmission service to a plurality of UEs. Different cells may provide different bandwidths. A base station controls data transmission/reception to/from a plurality of UEs. The base station transmits downlink scheduling information about downlink data to a UE to inform the UE of a time/frequency region in which the downlink data will be transmitted, coding information, data size, hybrid automatic repeat and request (HARQ) related information, etc. The base station transmits uplink scheduling information about uplink data to the UE to inform the UE of a time/frequency region that can be used by the UE, coding information, data size, HARQ related information, etc. An interface for user traffic or control traffic transmission may be used between base stations.

While wireless communication technology has been developed into LTE based on wideband code division multiple access (WCDMA), demands and expectations of users and providers continuously increase. Furthermore, technical evolution is needed for future competitiveness of wireless communication technology since other wireless access technologies are being developed. For technical evolution, reduction of cost per bit, service availability increase, flexible use of frequency band, simplified structure and open interface, appropriate power consumption of terminals, etc.

3GPP is standardizing follow-up technology to LTE referred to as ‘LTE-A’ in this specification. LTE and LTE-A mainly differ in terms of system bandwidth and introduction of a relay.

LTE-A aims to support a wideband of up to 100 MHz. To achieve this, carrier aggregation or bandwidth aggregation that accomplishes a wideband using a plurality of frequency blocks is employed. Carrier aggregation uses a plurality of frequency blocks as a large logical frequency band in order to use a wider frequency band. The bandwidth of each frequency block can be defined based on a system bandwidth used in LTE. Each frequency block is transmitted using a component carrier.

As LTE-A, a next-generation communication system, employs carrier aggregation, a method for receiving, at a UE, a signal from a base station or a relay in a system supporting a plurality of carriers is needed.

### DISCLOSURE

### Technical Problem

An object of the present invention devised to solve the problem lies in a method for UE-specifically or BS-specifically setting a component carrier supported by a BS in a carrier aggregation system and then transmitting component carrier configuration information including at least one item of downlink component carrier set information.

Another object of the present invention is to provide a method for transmitting component carrier configuration information to a UE in consideration of interference generated in a heterogeneous network environment.

### Technical Solution

The object of the present invention can be achieved by providing a method for allocating component carriers in a carrier aggregation system, including: receiving, from a base station, component carrier configuration information about a plurality of component carriers supported by the base station, wherein the component carrier configuration information includes at least one piece of component carrier set information, wherein the component carrier set information is downlink component carrier set information regarding downlink component carriers through which a physical downlink shared channel (PDSCH) is transmitted, uplink component carrier set information regarding uplink component carriers through which a physical uplink shared channel (PUSCH) is transmitted, or PDCCH monitoring component carrier set information regarding PDCCH monitoring component carriers through which a physical downlink control channel (PDCCH) is transmitted.

The component carrier configuration information may include component carrier type indication information indicating the type of each component carrier in the component carrier set.

The component carrier set information may be configured with indices indicating component carriers in the component carrier set or configured in the form of a bitmap.

The component carrier configuration information may be configured UE-specifically or cell-specifically.

The method may further include monitoring a plurality of PDCCHs through PDCCH monitoring component carriers based on the component carrier configuration information.

The component carrier type may be a first type component carrier corresponding to a backward compatible component carrier, a second type component carrier corresponding to a non-backward compatible component carrier or a third type component carrier corresponding to an extension component carrier.

The component carrier configuration information may be transmitted from the base station through RRC signaling.

The downlink component carrier set information may include the third type component carrier, the third type component carrier being linked to a first type component carrier or a second type component carrier in the downlink component carrier set.

The uplink component carrier set information may include the third type component carrier, the third type component carrier being linked to a first type component carrier or a second type component carrier in the uplink component carrier set.

The bitmap may be configured for activated component carriers.

In another aspect of the present invention, provided herein is a UE for component carrier allocation in a carrier aggregation system, including: an RF communication unit for transmitting/receiving an RF signal; and a controller connected to the RF communication unit, wherein the controller controls the RF communication unit to receive, from a base station, component carrier configuration information about a plurality of component carriers supported by the base station, wherein the component carrier configuration information includes at least one piece of component carrier set information, wherein the component carrier set information is downlink component carrier set information regarding downlink component carriers through which a physical downlink shared channel (PDSCH) is transmitted, uplink component carrier set information regarding uplink component carriers through which a physical uplink shared channel (PUSCH) is transmitted, or PDCCH monitoring component carrier set information regarding PDCCH monitoring component carriers through which a physical downlink control channel (PDCCH) is transmitted.

The component carrier configuration information may include component carrier type indication information indicating the type of each component carrier in the component carrier set.

The component carrier set information may be configured with indices indicating component carriers in the component carrier set or configured in the form of a bitmap.

The component carrier configuration information may be configured UE-specifically or cell-specifically.

The controller may monitor a plurality of PDCCHs through PDCCH monitoring component carriers based on the component carrier configuration information.

The component carrier type may be a first type component carrier corresponding to a backward compatible component carrier, a second type component carrier corresponding to a non-backward compatible component carrier or a third type component carrier corresponding to an extension component carrier.

### Advantageous Effects

According to the present invention, it is possible to reduce the number of unnecessary decoding operations of a UE by informing the UE of information about a downlink component carrier set transmitting a PDCCH, PDSCH and PUSCH and information about the type of each component carrier.

Furthermore, each BS can configure a downlink component carrier set in consideration of a neighboring BS to reduce interference generated in a heterogeneous network environment.

### DESCRIPTION OF DRAWINGS

FIG. 1 is a block diagram of a wireless communication system.

FIG. 2 is a block diagram of a UE and a BS according to an embodiment of the present invention.

FIG. 3 illustrates physical channels used for a 3GPP system and a method of transmitting a signal using the physical channels.

FIG. 4 illustrates a radio frame structure used in 3GPP LTE.

FIG. 5 illustrates downlink and uplink subframe structures of 3GPP LTE.

FIG. 6 illustrates a time-frequency resource grid structure of downlink used in the present invention.

FIG. 7 is a block diagram illustrating configuration of a PDCCH.

FIG. 8 illustrates an example of mapping resources of a PDCCH.

FIG. 9 illustrates CCE interleaving in a system bandwidth.

FIG. 10 illustrates PDCCH monitoring.

FIG. 11(a) illustrates management of multiple carriers by a plurality of MACs in a BS and FIG. 11(b) illustrates management of multiple carriers by a plurality of MACs in a UE.

FIG. 12(a) illustrates management of multiple carriers by a single MAC in a BS and FIG. 12(b) illustrates management of multiple carriers by a single MAC in a UE.

FIG. 13 illustrates exemplary multiple carriers.

FIG. 14 illustrates exemplary cross-carrier scheduling.

FIG. 15 illustrates an exemplary component carrier (CC) set.

FIG. 16 illustrates inter-cell interference.

FIG. 17 illustrates an example of applying downlink ICIC in the frequency domain.

FIG. 18 illustrates an example of applying downlink ICIC in the time domain.

FIG. 19 illustrates inter-cell interference in a heterogeneous network environment.

FIG. 20 is a flowchart illustrating a process performed by a UE for carrier aggregation.

FIG. 21(a) illustrates an exemplary PDCCH monitoring CC set and DL CC set in a multi-carrier system and FIG. 21(b) illustrates an exemplary UL CC set.

FIG. 22(a) shows a DL CC set in the form of a bitmap based on cell specific carrier configuration, FIG. 22(b) shows a UL CC set in the form of a bitmap based on cell specific carrier configuration and FIG. 22(c) shows a PDCCH monitoring CC set in the form of a bitmap based on a cell specific carrier configuration.

FIG. 23 illustrates an exemplary multi-carrier.

FIG. 24 illustrates an exemplary DL CC set that a BS attempts to signal to a UE.

FIG. 25 illustrates a PDCCH monitoring CC set and a DL CC set including a CC type added thereto in a multi-carrier system.

### BEST MODE

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete and will fully convey the scope of the invention to those skilled in the art. While the following description is given centering on 3GPP LTE/LTE-A by way of example, this is purely exemplary and thus should not be construed as limiting the present invention.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the following description, the term ‘terminal’ may be replaced with the term ‘user equipment (UE)’, ‘Mobile Station (MS)’, ‘advanced MS (AMS)’, etc. The term ‘base station (BS)’ may be replaced with the term ‘Node B’, ‘evolved Node B (eNode B or eNB)’, ‘Access Point (AP)’, etc. The term ‘relay’ may be replaced with the term ‘Relay Node (RN)’, ‘Relay Station (RS)’, etc.

In a mobile communication system, a UE and a relay may receive information from a BS through downlink and transmit information to the BS through uplink Information transmitted or received by the UE and relay includes data and control information and various physical channels are present according to type and purpose of information transmitted or received by the UE and relay.

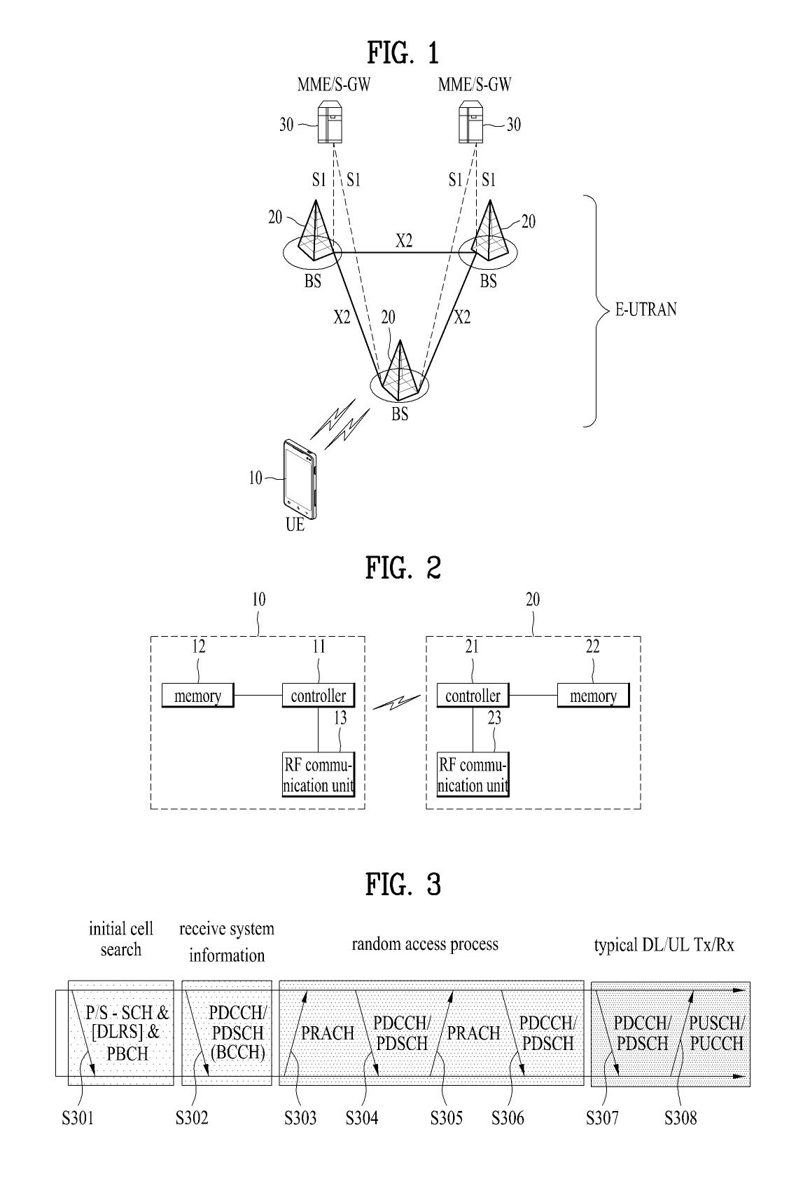

FIG. 1 is a block diagram of a wireless communication system.

The wireless communication system shown in FIG. 1 may be an E-UMTS (Evolved-Universal Mobile Telecommunication System) network. The E-UMTS system may be called LTE or LTE-A. The wireless communication system is widely deployed to provide various communication services such as audio, packet data, etc.

Referring to FIG. 1, E-UTRAN (Evolved-UMTS Terrestrial Radio Access Network) includes a BS 20 providing a control plane and a user plane.

A UE 10 may be fixed or mobile and the term ‘UE’ may be replaced by the term ‘mobile station (MS)’, ‘user terminal (UT)’, ‘subscriber station (SS)’, ‘wireless device’, etc.

The BS 20 refers to a fixed station communicating with the UE 10 and the term ‘BS’ is interchangeable with ‘evolved-NodeB (eNB)’, ‘base transceiver system (BTS)’, ‘access point’, etc. One BS 20 may include one or more cells. An interface for user traffic or control traffic transmission may be used between BSs 20.

In the following description, downlink refers to communication from the BS 20 to the UE 10 and uplink refers to communication from the UE 10 to the BS 20.

The BSs 20 may be linked to each other through an interface X2. Each BS 20 is connected to an EPC (Evolved Packet Core), specifically, an MME (Mobility Management Entity)/S-GW (Serving Gateway) 30 through an interface S1. The interface S1 supports a many-to-many-relation between the BS 10 and the MME/S-GW 30.

FIG. 2 is a block diagram showing components of the UE 10 and the BS 20.

The UE 10 includes a controller 11, a memory 12 and an RF unit 13.

In addition, the UE 10 includes a display unit, a user interface, etc.

The controller 11 implements proposed functions, processes and/or methods. Radio interface protocol layers may be implemented by the controller 11.

The memory 12 is connected to the controller 11 and stores protocols or parameters used to perform wireless communication. That is, the memory 12 stores a UE operating system, applications and general files.

The RF unit 13 is connected to the controller 11 and transmits and/or receives radio signals.

In addition, the display unit displays information of the UE and may use a known component such as an LCD (Liquid Crystal Display), OLED (Organic Light Emitting Diode) or the like. The user interface may be implemented as a combination of known user interfaces such as a keypad, touchscreen, etc.

The BS 20 includes a controller 21, a memory 22 and an RF unit 23.

The controller 21 implements proposed functions, processes and/or methods. Radio interface protocol layers may be implemented by the controller 21.

The memory 22 is connected to the controller 21 and stores protocols or parameters used to perform wireless communication.

The RF unit 23 is connected to the controller 21 and transmits and/or receives radio signals.

The controllers 11 and 21 may include an ASIC (application-specific integrated circuit), other chip sets, a logic circuit and/or a data processor. The memories 12 and 22 may include a ROM (read-only memory), RAM (random access memory), flash memory, memory card, storage medium and/or other storage devices. The RF units 13 and 23 may include a baseband circuit for processing radio signals. In a software implementation, the above-described components can be implemented as modules (processes, functions, etc.) that perform the above-described functions. The modules may be stored in the memories 12 and 22 and executed by the controllers 11 and 21.

The memories 12 and 22 may be located inside or outside the controllers 11 and 21 or may be connected to the controllers 11 and 21 through well-known means.

FIG. 3 illustrates physical channels used for a 3GPP system and a method of transmitting a signal using the physical channels.

When powered on or when a UE initially enters a cell, the UE performs initial cell search involving synchronization with a BS (S301). For initial cell search, the UE is synchronized with the BS and acquires information such as a cell ID by receiving a Primary Synchronization Channel (P-SCH) and a Secondary Synchronization Channel (S-SCH) from the BS. Then the UE may receive broadcast information from the cell on a physical broadcast channel. In the mean time, the UE may determine a downlink channel status by receiving a Downlink Reference Signal (DL RS) during initial cell search.

After initial cell search, the UE may acquire more specific system information by receiving a Physical Downlink Control Channel (PDCCH) and receiving a Physical Downlink Shared Channel (PDSCH) based on information of the PDCCH (S302).

When the UE initially accesses the BS or there is no radio resource for signal transmission, the UE may perform a random access procedure (RACH) to access the BS (S303 to S306). For random access, the UE may transmit a preamble to the BS on a Physical Random Access Channel (PRACH) (S303 and S305) and receive a response message for preamble on a PDCCH and a PDSCH corresponding to the PDCCH (S304 and S306). In the case of contention-based random access, the UE may additionally perform a contention resolution procedure.

After the foregoing procedure, the UE may receive a PDCCH/PDSCH (S307) and transmit a Physical Uplink Shared Channel (PUSCH)/Physical Uplink Control Channel (PUCCH) (S308), as a general downlink/uplink signal transmission procedure. Information transmitted from the UE to the BS or information transmitted from the BS to the UE through uplink includes a downlink/uplink ACK/NACK signal, a CQI (Channel Quality Indicator), a PMI (Precoding Matrix Index), an RI (Rank Indicator), etc. In the case of 3GPP LTE, the UE can transmit the CQI/PMI/RI on a PUSCH and/or a PUCCH.

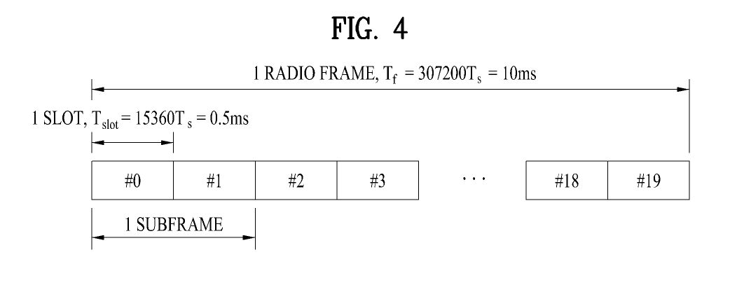

FIG. 4 illustrates a radio frame structure used in 3GPP LTE.

Referring to FIG. 4, a radio frame has a length of 10 ms (307200Ts) and includes 10 subframes of equal size. Each subframe has a length of 1 ms and includes two slots. 20 slots in the radio frame can be sequentially numbered from 0 to 19. Each slot has a length of 0.5 ms (15360Ts). Here, Ts denotes sampling time and is represented as Ts=1/(15 kHz×2048)=3.1552×10⁻⁸ (about 33 ns). Each slot includes a plurality of OFDM symbols or SC-FDMA symbols in the time domain and a plurality of resource blocks in the frequency domain.

In LTE, one resource block (RB) includes (12 subcarriers×7 (or 6) OFDM symbols or SC-FDMA (Single Carrier-Frequency Division Multiple Access) symbols). A unit time for transmitting data, a transmission time interval (TTI), may be defined based on one or more subframes. The above-described radio frame structure is exemplary and the number of subframes included in a radio frame, the number of slots included in a subframe and the number of OFDM symbols or SC-FDMA symbols included in a slot may be modified in various manner.

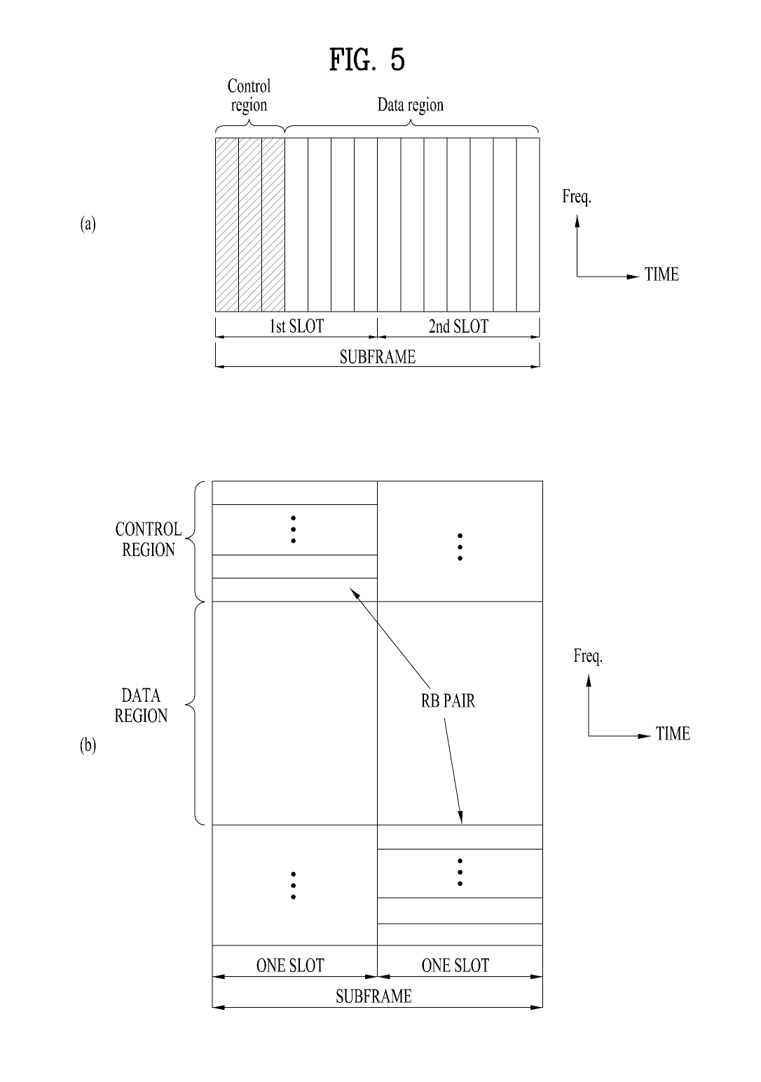

FIG. 5 illustrates downlink and uplink subframe structures of 3GPP LTE.

Referring to FIG. 5(a), a downlink subframe includes two slots in the time domain. A maximum of three OFDM symbols located in a front portion of the first slot within the subframe correspond to a control region to which control channels are allocated and the remaining OFDM symbols correspond to a data region to which a physical downlink shared chancel (PDSCH) is allocated.

Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols (i.e. control region size) used for transmission of control channels within the subframe. Control information transmitted through the PDCCH is called downlink control information (DCI). The DCI refers to uplink resource allocation information, downlink resource allocation information, an uplink transmission power control command for arbitrary UE groups, etc. The PHICH carries a HARQ acknowledgment (ACK)/negative acknowledgment (NACK) signal. That is, an ACK/NACK signal in response to uplink data transmitted from a UE is transmitted on the PHICH.

A brief description will be given of the PDCCH.

The PDCCH will be described below in detail with reference to FIGS. 7 to 10.

A BS may transmit resource allocation information and transport format of a PDSCH (referred to as DL grant), resource allocation information of a PUSCH (referred to as UL grant), a transmit power control command set with respect to individual UEs in a UE group, information about enabling Voice over IP (VoIP), etc. through a PDCCH. A plurality of PDCCHs can be transmitted in the control region. A UE can monitor the plurality of PDCCHs. The PDCCH is transmitted as an aggregate of one or more consecutive control channel elements (CCEs).

The PDCCH transmitted as an aggregate of one or more consecutive CCEs may be transmitted through the control region after being subjected to subblock interleaving. A CCE is a logical allocation unit used to provide a coding rate based on a radio channel state to the PDCCH. The CCE corresponds to a plurality of resource element groups (REGs). The format of the PDCCH and the number of bits of the PDCCH are determined on the basis of the relationship between the number of CCEs and a coding rate provided by the CCEs.

Control information transmitted on the PDCCH is referred to as downlink control information (DCI). Table 1 shows DCI according to DCI format.

TABLE 1

| DCI format | Content |
|---|---|
| DCI format 0 | Used for PUSCH scheduling |
| DCI format 1 | Used for scheduling of a PDSCH codeword |
| DCI format 1A | Used for compact scheduling and random access |
| | of a PDSCH codeword |
| DCI format 1B | Used for compact scheduling of a PDSCH codeword |
| | having precoding information |
| DCI format 1C | Used for very compact scheduling of a PDSCH codeword |
| DCI format 1D | Used for compact scheduling of a PDSCH codeword |
| | having precoding and power offset information |
| DCI format 2 | Used for PDSCH scheduling of UEs set to closed-loop |
| | spatial multiplexing mode |
| DCI format 2A | Used for PDSCH scheduling of UEs set to open-loop |
| | spatial multiplexing mode |
| DCI format 3 | Used for transmission of a TPC command of a PUCCH |
| | and PUSCH having 2-bit power adjustments |
| DCI format 3A | Used for transmission of a TPC command of a PUCCH |
| | and PUSCH having 1-bit power adjustments |

DCI format 0 refers to uplink resource allocation information, DCI formats 1 and 2 refer to downlink resource allocation information, and DCI formats 3 and 3A refer to an uplink transmit power control (TPC) command for arbitrary UE groups.

A description will be given of a method of mapping resources by a BS to transmit a PDCCH in an LTE system.

The BS can transmit scheduling allocation information and control information through a PDCCH. A physical control channel can be transmitted as an aggregate or a plurality of continuous control channel elements (CCEs). A CCE includes 9 resource element groups (REGs).

The number of REGs that are not allocated to a PCFICH (Physical Control Format Indicator Channel) or PHICH (Physical Hybrid Automatic Repeat Indicator Channel) is N_{REG}. CCEs available in the system correspond to 0 to N_{REG}−1 (N_{CCE}=└N_{REG}/9┘). The PDCCH supports multiple formats as shown in FIG. 3. One PDCCH composed of n continuous CCEs starts at a CCE performing an operation of i mod n=0 (i being a CCE number). Multiple PDCCHs can be transmitted in one subframe.

TABLE 2

| PDCCH | Number | Number of resource | Number of |
|---|---|---|---|
| format | of CCEs | element groups | PDCCH bits |
| 0 | 1 | 9 | 72 |
| 1 | 2 | 18 | 144 |
| 2 | 4 | 36 | 288 |
| 3 | 8 | 72 | 576 |

Referring to FIG. 2, the BS can determine a PDCCH format according to how many regions are used to transmit control information. A UE can reduce overhead by reading control information on a CCE basis. Similarly, a relay can read control information of an R-CCE basis. In LTE-A, resource elements (REs) can be mapped based on an R-CCE (Relay-Control Channel Element).

Referring to FIG. 5(b), an uplink subframe can be divided into a control region and a data region in the frequency domain. The control region is allocated to a PUCCH (Physical Uplink Control Channel) carrying uplink control information. The data region is allocated to a PUSCH (Physical Uplink Shared Channel) carrying user data. In order to maintain single carrier characteristics, one UE does not simultaneously transmit the PUCCH and the PUSCH. The PUCCH for one UE is allocated to an RB pair in a subframe. RBs belonging to the RB pair occupy different subcarriers with respect to two slots.

The RB pair allocated to the PUCCH is frequency-hopped at a slot edge.

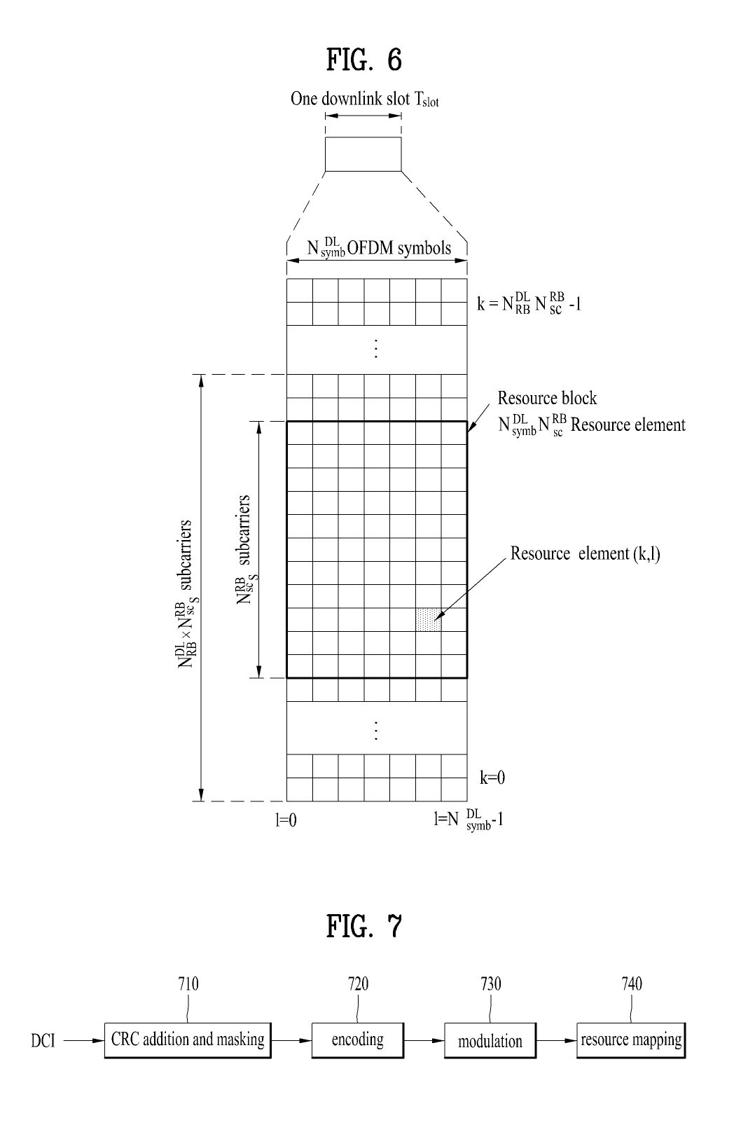

FIG. 6 illustrates a downlink time-frequency resource grid structure used in the present invention.

A downlink signal transmitted in each slot uses a resource grid structure composed of N_{RB}^{DL}×N_{SC}^{RB} subcarriers and N_{symb}^{DL} OFDM (Orthogonal Frequency Division Multiplexing) symbols. Here, N_{RB}^{DL} denotes the number of RBs on downlink, N_{SC}^{RB} denotes the number of subcarriers constituting one RB, and N_{symb}^{DL} represents the number of OFDM symbols in one downlink slot. N_{RB}^{DL} varies with downlink transmission bandwidth configured in a cell and needs to satisfy N_{RB}^{min,DL}≦N_{RB}^{DL}≦N_{RB}^{max,DL}. Here N_{RB}^{min,DL} is a minimum downlink bandwidth supported by the wireless communication system and N_{RB}^{max,DL} is a maximum downlink bandwidth supported by the wireless communication system. While N_{RB}^{min,DL} may be 6 and N_{RB}^{max,DL} may be 110, the downlink bandwidths are not limited thereto. The number of OFDM symbols included in one slot may depend on cyclic prefix (CP) length and subcarrier spacing. In the case of multi-antenna transmission, one resource gird per antenna port can be defined.

Each element in a resource grid with respect to each antenna port is called a resource element (RE) and identified by an index pair (k, l) in a slot.

Here, k is an index in the frequency and has one of values of 0, . . . , N_{RB}^{DL}N_{SC}^{RB}−1 and 1 is an index in the time domain and has one of values of 0, . . . , N_{RB}^{DL}−1.

An RB illustrated in FIG. 6 is used to describe the mapping relationship between a physical channel and REs. RBs may be categorized into Physical Resource Blocks (PRBs) and Virtual Resource Blocks (VRBs). A PRB is defined by N_{symb}^{DL} contiguous OFDM symbols in the time domain and N_{SC}^{RB} contiguous subcarriers in the frequency domain. N_{symb}^{DL} and N_{SC}^{RB} may be preset. For example, N_{smyb}^{DL} and N_{SC}^{RB} may be given as illustrated in Table 3 below. Therefore, one PRB includes N_{symb}^{DL}×N_{SC}^{RB} REs. One PRB may correspond to one slot in the time domain and 180 kHz in the frequency domain, which should not be construed as limiting the present invention.

TABLE 3
N_{SC}^{RB}

12
6
3

A PRB has a number ranging from 0 to N_{RB}^{DL}−1 in the frequency domain. The relationship between a PRB number n_{PRB} in the frequency domain and an RE (k, l) in a slot satisfies

$${n}_{PRB} = ⌊ \frac{k}{{N}_{SC}^{RB}} ⌋ .$$

The size of a VRB is equal to that of a PRB. VRBs may be classified into LVRB (Localized VRB) and DVRB (Distributed VRB). For each VRB type, a pair of VRBs located in the two slots of a subframe are labeled with the same single VRB number, n_{VRB}.

The VRB and PRB may be of the same size. VRBs may be classified into LVRB and DVRB. For each VRB type, each of a pair of VRBs may be labeled with the same VRB index (or the same VRB number) and allocated across the two slots of a subframe. In other words, one of indexes 0 to N_{RB}^{DL}−1 is assigned to each of N_{RB}^{DL} VRBs in the first slot of a subframe and to each of N_{RB}^{DL} VRBs in the second slot of the subframe.

The above-described radio frame, downlink subframe, uplink subframe and downlink time-frequency resource grid structures illustrated in FIGS. 2, 3 and 4 are also applicable between a BS and a relay.

An operation for transmitting a PDCCH to a UE by a BS in the LTE system will be described below.

Referring to FIG. 7,

The BS determines a PDCCH format according to DCI to be transmitted to the UE and adds a CRC (Cyclic Redundancy Check) to the DCI. The CRC is masked by an ID known as an RNTI (Radio Network Temporary Identifier) according to the owner or usage of the PDCCH (710).

If the PDCCH is directed to a specific UE, the CRC of the PDCCH may be masked by an ID of the UE, for example, C-RNTI (Cell-RNTI). If the PDCCH carries a paging message, the CRC of the PDCCH may be masked by a P-RNTI (Paging RNTI). If the PDCCH is a PDCCH carrying system information, the CRC of the PDCCH may be masked by a system information ID, SI-RNTI (System Information RNTI). To indicate that the PDCCH carries a random access response to a random access preamble transmitted by a UE, the CRC of the PDCCH may be masked by an RA-RNTI (Random Access-RNTI). The CRC of the PDCCH may be masked by a TPC-RNTI (Transmit Power Control RNTI) to indicate a TPC command.

If the C-RNTI is used, the PDCCH carries control information specific to a UE (which is called UE-specific control information). If any other RNTI is used, the PDCCH carries common control information that all or a plurality of UEs within a cell are supposed to receive.

The BS generates coded data by encoding DCI including a CRC attached thereto (720). Encoding includes channel encoding and rate matching.

The coded data is modulated to generate modulated symbols (730).

The modulated symbols are mapped to physical REs (740). Each modulated symbol is mapped to each RE.

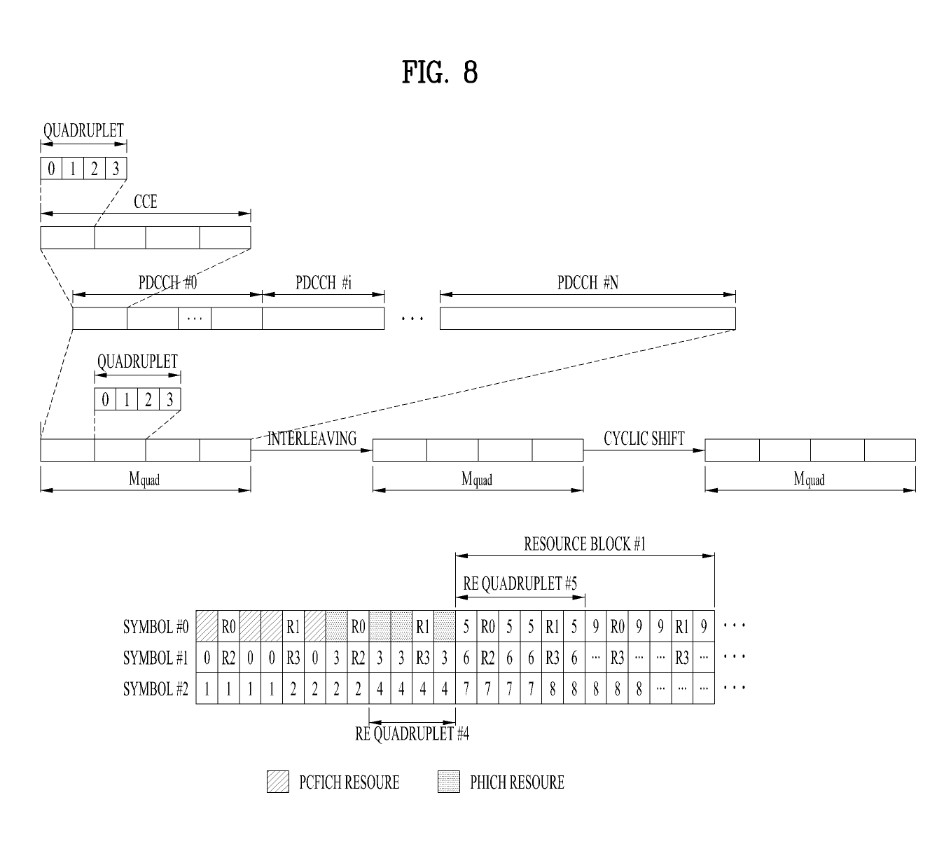

FIG. 8 illustrates an example of mapping resources of a PDCCH.

Referring to FIG. 8, R0, R1, R2 and R3 respectively represent a reference signal of a first antenna, a reference signal of a second antenna, a reference signal of a third antenna and a reference signal of a fourth antenna.

A control region in a subframe includes a plurality of CCEs. A CCE is a logical allocation unit used to provide a coding rate based on a radio channel status to a PDCCH and corresponds to a plurality of REGs. An REG includes a plurality of REs. A PDCCH format and the number of available PDCCH bits are determined based on the relationship between the number of CCEs and a coding rate provided by CCEs.

One REG (represented as a quadruplet in FIG. 8) includes 4 REs and one CCE includes 9 REGs. {1, 2, 4, 8} CCEs may be used to configure one PDCCH. Each element of {1, 2, 4, 8} CCEs is referred to as a CCE aggregation level.

A control channel composed of one or more CCEs is subjected to REG based interleaving and cyclic shift based on a cell ID and then mapped to physical resources.

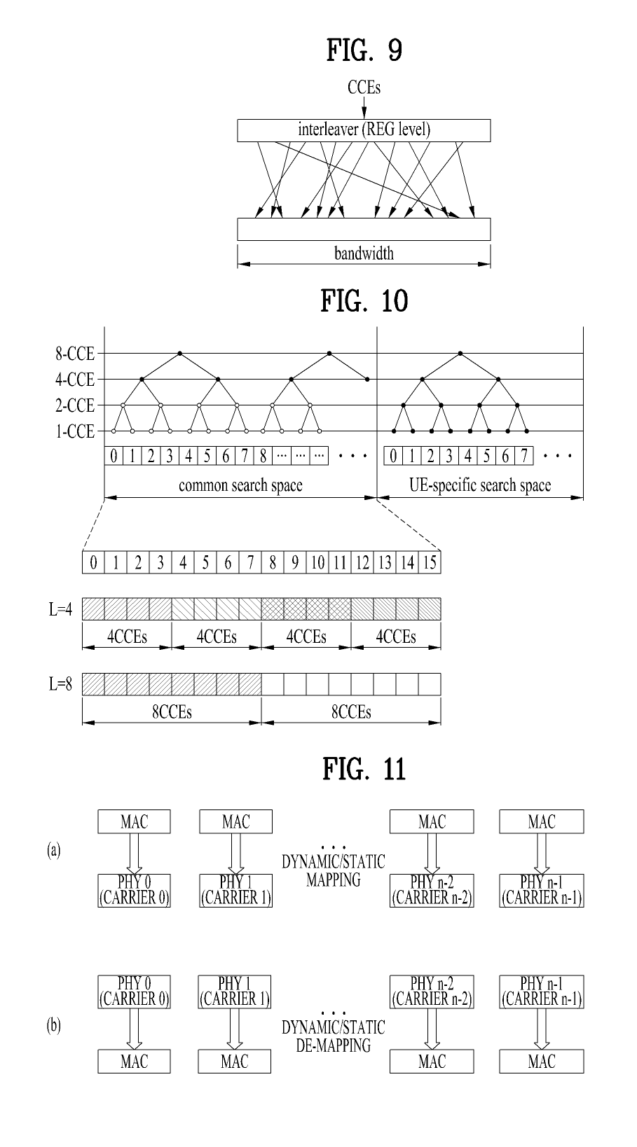

FIG. 9 illustrates an example of distributing CCEs across a system band.

Referring to FIG. 9, logically successive CCEs are input to an interleaver. The interleaver permutes the order of the received CCEs on an REG basis.

Therefore, the frequency/time resources of one CCE are physically distributed across the frequency/time domain within the control region of a subframe. As a consequence, even though a control channel is configured with CCEs, interleaving is performed on an REG basis, thereby maximizing diversity and interference randomization gains.

FIG. 10 illustrates PDCCH monitoring.

In 3GPP LTE, blind decoding is used to detect a PDCCH. Blind decoding is performed by a UE to check CRC error by demasking a CRC of a received PDCCH (referred to as a PDCCH candidate) by a desired identifier so as to check whether the PDCCH is a control channel directed to the UE. The UE does not know a position in a control region and a CCE aggregation level or a DCI format, which are used to transmit a PDCCH directed thereto.

A plurality of PDCCHs can be transmitted per subframe. The UE monitors a plurality of PDCCHs in every subframe. Here, monitoring means that the UE attempts to decode a monitored PDCCH according to the format of the monitored PDCCH.

In 3GPP LTE, a search space is used in order to reduce a load caused by blind decoding. The search space may be called a CCE monitoring set for a PDCCH. The UE monitors PDCCHs in a search space corresponding thereto.

Search spaces may be categorized into a common search space and a UE-specific search space. The common search space is accessed to search PDCCHs having common control information and is configured with 16 CCEs corresponding to CCE indices 0 to 15. The common search space supports PDCCHs having {4, 8} CCE aggregation levels. However, PDCCHs (DCI formats 0 and 1A) carrying UE-specific information may be transmitted in the common search space. The UE-specific search space supports PDCCHs having {1, 2, 4, 8} CCE aggregation levels.

Table 4 shows the number of PDCCH candidates monitored by a UE.

TABLE 4

| Search space | Aggregation | Size | Number of PDCCH | DCI |
|---|---|---|---|---|
| type | level L | [in CCEs] | candidates | formats |
| UE-specific | 1 | 6 | 6 | 0, 1, 1A, |
| | 2 | 12 | 6 | 1B, 1D, |
| | 4 | 8 | 2 | 2, 2A |
| | 8 | 16 | 2 | |
| Common | 4 | 16 | 4 | 0, 1A, 1C, |
| | 8 | 16 | 2 | 3/3A |

A search space size is determined by Table 4 and common and UE-specific search space start points are differently defined. The common search space start point is fixed irrespective of a subframe, whereas the UE-specific search space start point may vary between subframes according to a UE identifier (e.g. C-RNTI), CCE aggregation level and/or slot number in a radio frame. If the UE-specific search space start point is included in the common search space, the UE-specific search space and the common search space may overlap.

A search space S^{(L)}K at an aggregation level Lε{1, 2, 3, 4} is defined as a set of PDCCH candidates. CCEs corresponding to a PDCCH candidate m of the search space S^{(L)}K are given as follows.

L·{(Yₖ+m)mod └N_{CCE,k}/L┘}+i Equation 1

Here, i=0, 1, . . . , L−1, m=0, . . . , M^{(L)}−1, N_{CCE,k} denotes the number of CCEs available to transmit the PDCCH in the control region of a subframe k. The control region includes a set of CCEs numbered from 0 to N_{CCE,k}−1. M^{(L)} denotes the number of PDCCH candidates at a CCE aggregation level L in the given search space. In a common search space, Yₖ is set to 0 for aggregation levels, L=4 and L=8. In the UE-specific search space of the aggregation level L, Yₖ is defined as follows.

Yₖ=(A·Yₖ₋₁)mod D Equation 2

Here, Yₖ₋₁=n_{RNTI}≠0, A=39827, D=65537, k=floor(nₛ/2), and nₛ is a slot number in a radio frame.

When a UE monitors a PDCCH using a C-RNTI, a monitored DCI format and search space are determined according to a PDSCH transmission mode.

Table 5 shows examples of PDCCH monitoring for which a C-RNTI is set.

TABLE 5

| Trans- | | | |
|---|---|---|---|
| mission | | | PDSCH transmission mode |
| mode | DCI format | Search space | according to PDCCH |
| Mode 1 | DCI format 1A | Common and | Single antenna port, |
| | | UE-specific | port 0 |
| | DCI format 1 | UE-specific | Single antenna port, |
| | | | port 1 |
| Mode 2 | DCI format 1A | Common and | Transmit diversity |
| | | UE-specific | |
| | DCI format | UE-specific | Transmit diversity |
| Mode 3 | DCI format 1A | Common and | Transmit diversity |
| | | UE-specific | |
| | DCI format 2A | UE-specific | CDD (Cyclic Delay |
| | | | Diversity) or |
| | | | transmit diversity |
| Mode 4 | DCI format 1A | Common and | Transmit diversity |
| | | UE-specific | |
| | DCI format 2 | UE-specific | Closed-loop spatial |
| | | | multiplexing |
| Mode 5 | DCI format 1A | Common and | Transmit diversity |
| | | UE-specific | |
| | DCI format 1D | UE-specific | MU-MIMO (Multi-User |
| | | | Multiple Input |
| | | | Multiple Output) |
| Mode 6 | DCI format 1A | Common and | Transmit diversity |
| | | UE-specific | |
| | DCI format 1B | UE-specific | Closed-loop spatial |
| | | | multiplexing |
| Mode 7 | DCI format 1A | Common and | Single antenna port, |
| | | UE-specific | port 0 if the number |
| | | | of PBCH transmission |
| | | | ports is 1 and transmit |
| | | | diversity if not. |
| | DCI format 1 | UE-specific | Single antenna port, |
| | | | port 5 |
| Mode 8 | DCI format 1A | Common and | Single antenna port, |
| | | UE-specific | port 0 if the number |
| | | | of PBCH transmission |
| | | | ports is 1 and transmit |
| | | | diversity if not. |
| | DCI format 2B | UE-specific | Dual layer transmission |
| | | | (port 7 or 8) or single |
| | | | antenna port, port 7 or 8 |

A description will be given of a multi-carrier system.

3GPP LTE supports a case in which a downlink bandwidth is different from an uplink bandwidth on the assumption that one component carrier (CC) is present.

That is, 3GPP LTE supports a case in which a downlink bandwidth and an uplink bandwidth are equal to or different from each other when one CC is defined for each of downlink and uplink. For example, 3GPP LTE supports a maximum of 20 MHz and defines only one CC for uplink and downlink although an uplink bandwidth may be different from a downlink bandwidth.

Spectrum aggregation (or bandwidth aggregation or carrier aggregation) supports a plurality of CCs. Spectrum aggregation was introduced to support increased throughput, prevent cost increase due to introduction of a wideband RF (radio frequency) device and secure backward compatibility. For example, if 5 CCs are allocated as granularity of a carrier having a bandwidth of 20 MHz, spectrum aggregation can support a maximum of 100 MHz.

Spectrum aggregation can be classified into contiguous spectrum aggregation corresponding to aggregation of carriers contiguous in the frequency domain and non-contiguous spectrum aggregation corresponding to aggregation of non-contiguous carriers. The number of aggregated carriers of downlink may be different from the number of aggregated carriers of uplink. A case in which the number of downlink CCs equals the number of uplink CCs is referred to as symmetrical aggregation and a case in which the number of downlink CCs is different from the number of uplink CCs is referred to as asymmetrical aggregation.

A component carrier may be called a ‘cell’.

‘Cell’ refers to selective combination of uplink resources with downlink resources. Linkage between a carrier frequency of downlink resources and a carrier frequency of uplink resources can be determined through system information transmitted through the downlink resources.

That is, ‘cell’ may refer to a pair of a downlink component carrier and an uplink component carrier or only the downlink component carrier. The uplink component carrier is a component carrier linked with the downlink component carrier.

‘Cell’ may represent a DL CC and UL CC pair or a DL CC.

‘Cell’ is discriminated from a cell as an area covered by a BS. In the following, ‘cell’ can be used interchangeably with component carrier (CC). In this case, ‘cell’ refers to the above-described component carrier (CC).

CCs may have different sizes (bandwidths). For example, if 5 CCs are used for 70 MHz, a 5 MHz carrier (CC #0)+20 MHz carrier (CC #1)+20 MHz carrier (CC #2)+20 MHz carrier (CC #3)+5 MHz carrier (CC #4) can be configured.

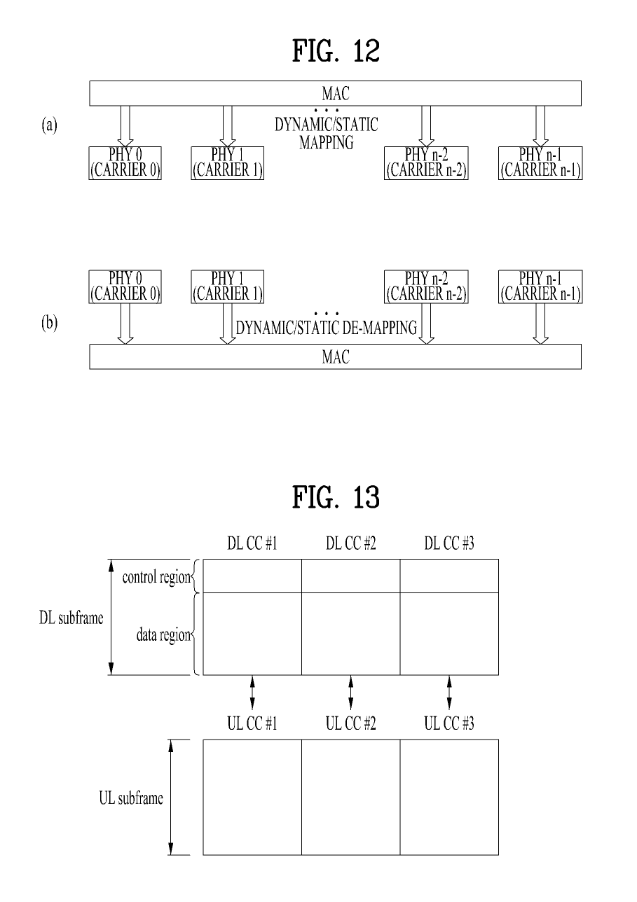

A physical layer (PHY) and layer 2 (MAC) for transmission with respect to a plurality of uplink or downlink carrier bandwidths allocated to a cell or a UE may be configured as illustrated in FIGS. 11 and 12.

FIG. 11(a) illustrates management of multiple carriers by a plurality of MAC layers in a BS and FIG. 11(b) illustrates management of multiple carriers by a plurality of MAC layers in a UE.

As shown in FIGS. 11(a) and 11(b), each carrier may be controlled by each MAC layer. In a system supporting a plurality of carriers, carriers may be contiguous or non-contiguous irrespective of uplink/downlink. A TDD system is configured to operate N carriers for downlink and uplink transmission among carriers and an FDD system is configured to use a plurality of carriers for each of uplink and downlink. The FDD system can also support asymmetrical carrier aggregation in which the number and/or bandwidth of carriers aggregated on uplink are different from those of carriers aggregated on downlink.

FIG. 12(a) illustrates management of multiple carriers by a MAC layer in a BS and FIG. 12(b) illustrates management of multiple carriers by a MAC layer in a UE.

As shown in FIGS. 12(a) and 12(b), one MAC layer performs transmission and reception by managing and operating one or more frequency carriers. Since frequency carriers managed by one MAC layer need not be contiguous, resource management is more flexible. In FIGS. 12(a) and 12(b), one PHY layer refers to one component carrier. Here, one PHY layer does not mean an independent RF device. While one independent RF device refers to one PHY layer in general, the RF device is not limited thereto and can include a plurality of PHY layers.

A PDCCH for transmitting L1/L2 control signaling control information generated from a packet scheduler of the MAC layer for supporting configurations of FIGS. 12(a) and 12(b) may be mapped to physical resources for each CC and then transmitted.

Particularly, a PDCCH with respect to channel allocation related to transmission of a PDSCH or PUSCH (physical uplink shared channel) of a UE or grant related control information may be encoded separately for each component carrier carrying a corresponding physical shared channel and generated as a separate PDCCH. This PDCCH is referred to as a separate coded PDCCH. Alternatively, control information for transmitting PDSCH or PUSCH to a specific UE may be separately encoded at every CC carrying the corresponding PDSCH/PUSCH. This PDCCH may be called a joint coded PDCCH.

To support downlink or uplink carrier aggregation, connection between a BS and a UE or RN needs to be established and preparation for connection setup between the BS and the UE is needed in such a manner that a PDCCH and/or PUCCH can be transmitted. In order to perform the above-mentioned connection or connection setup for a specific UE or RN, measurement and/or reporting for each carrier are needed and CCs serving as the measurement and/or reporting targets may be assigned.

The BS may transmit component carrier allocation information through UE-specific or RN-specific RRC signaling according to dynamic control when CC assignment is controlled in L3 radio resource management (RRM). The BS can transmit the component carrier allocation information through a predetermined PDCCH for L1/L2 control signaling, or a dedicated physical control channel for CC assignment control information.

FIG. 13 illustrates exemplary multiple carriers.

While 3 DL CCs and 3 UL CCs are illustrated in FIG. 13, the number of DL CCs and the number of UL CCs is not limited thereto. A PDCCH and a PDSCH are independently transmitted in each DL CC and a PUCCH and a PUSCH are independently transmitted in each UL CC.

In the following description, a multi-carrier system refers to a system supporting multiple carriers based on spectrum aggregation as described above.

In the multi-carrier system, contiguous spectrum aggregation and/or non-contiguous spectrum aggregation may be used and symmetrical aggregation or asymmetrical aggregation may be used.

In the multi-carrier system, linkage between a DL CC and a UL CC can be defined. A linkage may be configured through EARFCN information included in downlink system information using fixed DL/UL Tx/Rx separation relation. The linkage refers to a mapping relationship between a DL CC through which a PDCCH carrying a UL grant is transmitted and a UL CC using the UL grant.

Otherwise, the linkage may refer to a mapping relationship between a DL CC (or UL CC) carrying data for HARQ and a UL CC (or DL CC) carrying a HARQ ACK/NACK signal. Linkage information is part of a higher layer message such as an RRC message or system information and may be signaled from a BS to a UE. Linkage between a DL CC and a UL CC may be fixed or changed between cells/UEs.

A separate coded PDCCH can carry control information such as control information about resource allocation for a PDSCH/PUSCH with respect to one carrier. That is, a PDSCH corresponds to a PDCCH and a PUSCH corresponds to a PDCCH.

A joint coded PDCCH can carry control information about resource allocation for PDSCHs/PUSCHs with respect to a plurality of CCs. In this case, one PDCCH may be transmitted through one CC or a plurality of CCs.

While separate coding will be described based on a PDCCH-PDSCH in the following, separate coding can be equally applied to a PDCCH-PUSCH.

The multi-carrier system can employ two CC scheduling methods.

According to the first method, a PDCCH-PDSCH pair is transmitted through one CC. This CC is called a self-scheduling CC. A UL CC through which a PUSCH is transmitted is a CC linked to a DL CC through which the corresponding PDCCH is transmitted.

That is, the PDCCH allocates a PDSCH on the same CC or allocates a PUSCH on a linked UL CC.

According to the second method, a DL CC through which a PDSCH is transmitted or a UL CC through which a PUSCH is transmitted is determined irrespective of a DL CC through which a PDCCH is transmitted. That is, the PDSCH and PUSCH are transmitted through different DL CCs or the PUSCH is transmitted through a UL CC that is not linked to the DL CC through which the PDCCH is transmitted. This is called cross-carrier scheduling.

A CC through which a PDCCH is transmitted is referred to as a PDCCH carrier, a monitoring carrier or a scheduling carrier and a CC through which a PDSCH/PUSCH is transmitted is referred to as a PDSCH/PUSCH carrier or a scheduled carrier.

Cross-carrier scheduling can be enabled/disabled for each UE and a UE for which cross-carrier is enabled can receive DCI including a CIF. The UE can be aware of a scheduled CC corresponding to a received PDCCH from the CIF included in the DCI.

DL-UL linkage predefined by cross-carrier scheduling can be overridden. That is, cross-carrier scheduling can schedule CCs other than a linked CC irrespective of DL-UL linkage.

FIG. 14 illustrates exemplary cross-carrier scheduling.

It is assumed that DL CC #1 and UL CC #1 are linked to each other, DL CC #2 and UL CC #2 are linked to each other and DL CC #3 and UL CC #3 are linked to each other.

A first PDCCH 1401 of DL CC #1 carries DCI regarding a PDSCH 1402 of DL CC #1. A second PDCCH 1411 of DL CC #1 carries DCI regarding a PDSCH 1412 of DL CC #2. A third PDCCH 1421 of DL CC #1 carries DCI regarding a PUSCH 1422 of UL CC #3 that is not linked.

For cross-carrier scheduling, DCI of a PDCCH can include a carrier indicator field (CIF). The CIF indicates a DL CC or a UL CC scheduled through DCI. For example, the second PDCCH 1411 can include a CIF indicating DL CC #2 and the third PDCCH 1421 can include a CIF indicating UL CC #3.

The CIF of the third PDCCH 1421 may be indicated as a CIF value corresponding to a DL CC instead of a CIF value corresponding to a UL CC.

That is, the CIF of the third PDCCH 1421 can indirectly designate UL CC #3 scheduling a PUSCH by indicating DL CC #3 linked to UL CC #3 because, if DCI of a PDCCH includes PUSCH scheduling information and a CIF included in the DCI indicates a DL CC, a UE can determine PUSCH scheduling on a UL CC linked to the DL CC.

Accordingly, it is possible to indicate a larger number of CCs using a CIF having a limited bit length (e.g. CIF having 3 bits), compared to a method of indicating all DL/UL CCs.

A UE using cross-carrier scheduling needs to monitor PDCCHs of a plurality of scheduled CCs for the same DCI format in a control region of one scheduled CC. For example, if plural DL CCs have different transmission modes, the UE can monitor a plurality of PDCCHs with respect to different DCI formats in each DL CC. If DL CCs have different bandwidths even though the same transmission mode is used, different DCI format payload sizes are present in the same DCI format and thus a plurality of PDCCHs can be monitored.

Consequently, the UE needs to monitor PDCCHs with respect to a plurality of DCI in a control region of a monitoring CC according to transmission mode for each CC and/or bandwidth when cross-carrier scheduling is enabled. Accordingly, a search space configuration and PDCCH monitoring for supporting the UE are needed.

Terms used for the multi-carrier system are defined.

UE DL CC set: set of DL CCs scheduled for a UE to receive a PDSCH

UE UL CC set: set of UL CCs scheduled for a UE to transmit a PUSCH

PDCCH monitoring CC set: set of at least one DL CC performing PDCCH monitoring. The PDCCH monitoring CC set may be identical to the UE DL CC set or may be a subset of the UE DL CC set. The PDCCH monitoring CC set can include at least one of DL CCs in the UE DL CC set. The PDCCH monitoring CC set can be separately defined irrespective of the UE DL CC set. DL CCs included in the PDCCH monitoring CC set can be set such that self-scheduling for UL CCs linked thereto can be performed all the time.

The UE DL CC set, UE UL CC set and PDCCH monitoring CC set can be cell-specifically or UE-specifically set.

DCI formats that can include a CIF are as follows.
DCI formats do not include a CIF when a CRC is scrambled by a P-RNTI, RA-RNTI or TC-RNTI.
DCI formats 0, 1, 1A, 1B, 1D, 2, 2A and 2B that can be received in a UE-specific search space can include a CIF if a CRC is scrambled (or masked) by a C-RNTI or SP S-RNTI.

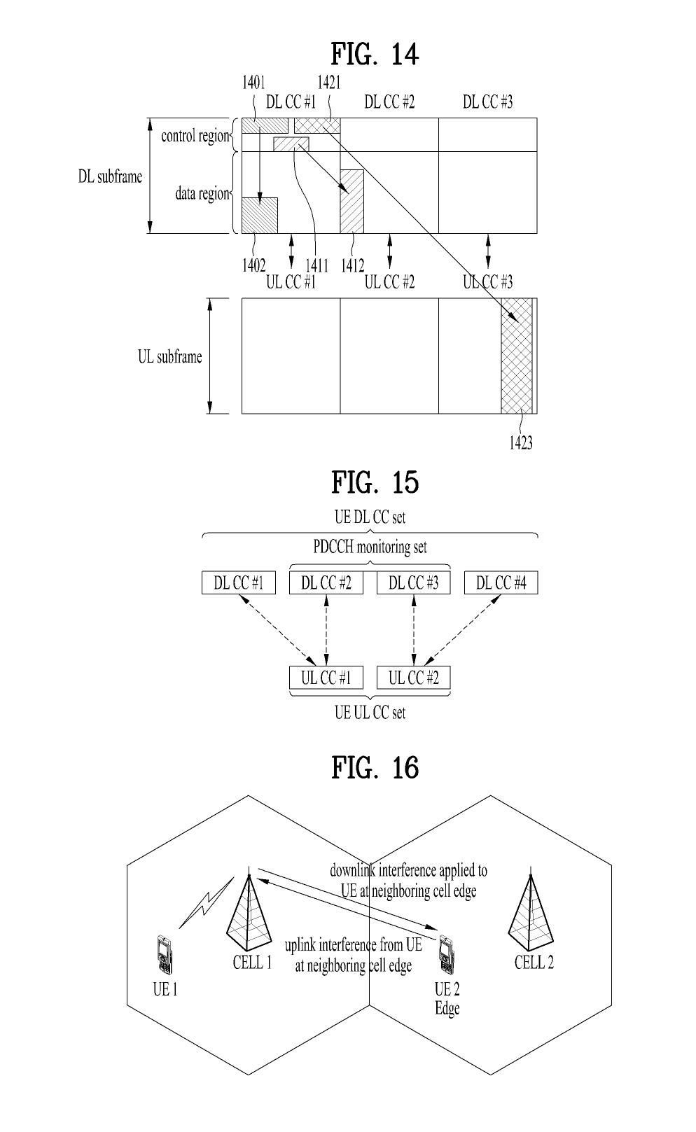

FIG. 15 illustrates an exemplary CC set. 4 DL CCs (DL CCs #1, #2, #3 and #4) are allocated to a UE DL CC set, 2 UL CCs (UL CCs #1 and #2) are allocated to a UE UL CC set and 2 DL CCs (DL CCs #2 and #3) are allocated to a PDCCH monitoring CC set.

DL CC #2 in the PDCCH monitoring CC set transmits a PDCCH with respect to a PDSCH corresponding to DL CC #1/#2 in the UE DL CC set and a PDCCH with respect to a PUSCH corresponding to UL CC #1 in the UE UL CC set. DL CC #3 in the PDCCH monitoring CC set transmits a PDCCH with respect to a PDSCH corresponding to DL CC #3/#4 in the UE DL CC set and a PDCCH with respect to a PUSCH corresponding to UL CC #2 in the UE UL CC set.

Linkages may be established between CCs included in the UE DL CC set, UE UL CC set and PDCCH monitoring CC set. In the example of FIG. 13, a PDCCH-PDSCH linkage is established between DL CC #2 corresponding to a scheduling CC and DL CC #1 corresponding to a scheduled CC and a PDCCH-PUSCH linkage is established between DL CC #2 and UL CC #1. In addition, a PDCCH-PDSCH linkage is established between DL CC #3 corresponding to a scheduling CC and DL CC #4 corresponding to a scheduled CC and a PDCCH-PUSCH linkage is established between DL CC #3 and UL CC #2. A BS can signal information about scheduling CCs and PDCCH-PDSCH/PUSCH linkage information to a UE through cell-specific or UE-specific signaling.

A DL CC and a UL CC may not be linked to each other for each DL CC included in the PDCCH monitoring CC set. DL CCs included in the PDCCH monitoring CC set are linked to DL CCs included in the UE DL CC set and a UL CC for PUSCH transmission may be limited to a UL CC linked to a DL CC in the UE DL CC set.

A CIF can be set depending on linkage of the UE DL CC set, UE, UL CC set and PDCCH monitoring CC set.

A description will be given of inter-cell interference coordination (ICIC) with reference to the attached drawings.

FIG. 16 illustrates inter-cell interference.

Referring to FIG. 16, when a UE is located at a cell edge, inter-cell interference becomes severe on downlink and uplink. A BS of cell 1 interferes with a cell-edge UE in cell 2 on downlink and the cell-edge UE in cell 2 interferes with the BS of cell 1 on uplink.

To solve this interference problem, each BS performs ICIC for neighboring BSs. ICIC can be performed in both a frequency resource region and a time resource region. That is, a resource period in which low-efficiency transmission is performed or transmission is not performed is defined in each resource region and a service is provided to a cell-edge UE of a neighboring BS in the resource period to mitigate or eliminate the influence of interference.

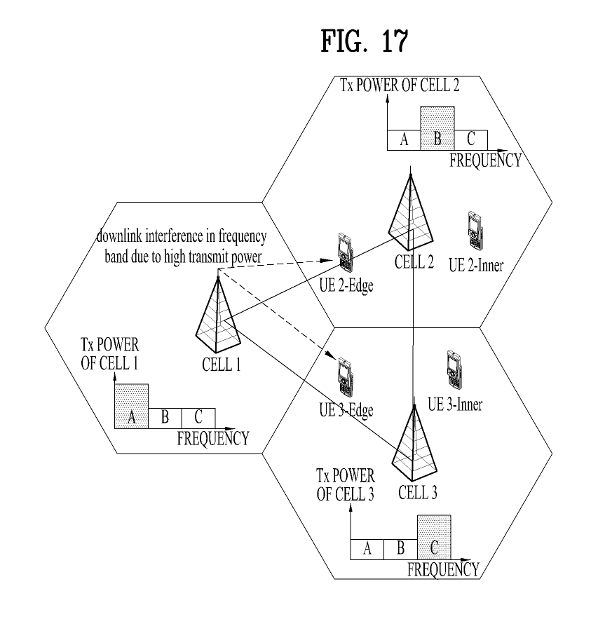

FIG. 17 illustrates an example of applying downlink ICIC in the frequency domain.

Referring to FIG. 17, the entire frequency domain is divided into bands A, B and C and the three bands are designated as a band in which each BS performs transmission with low power and a band in which each BS performs transmission with high power for interference control. That is, since BS 1 performs transmission with low power in bands B and C, BS 2 can mitigate interference by allocating a cell-edge UE severely interfered by BS 1 to bands B and C in which the cell-edge UE is less interfered. In this manner, all BSs can alleviate the influence of inter-cell interference by allocating cell-edge UEs to a resource region that can be protected from interference.

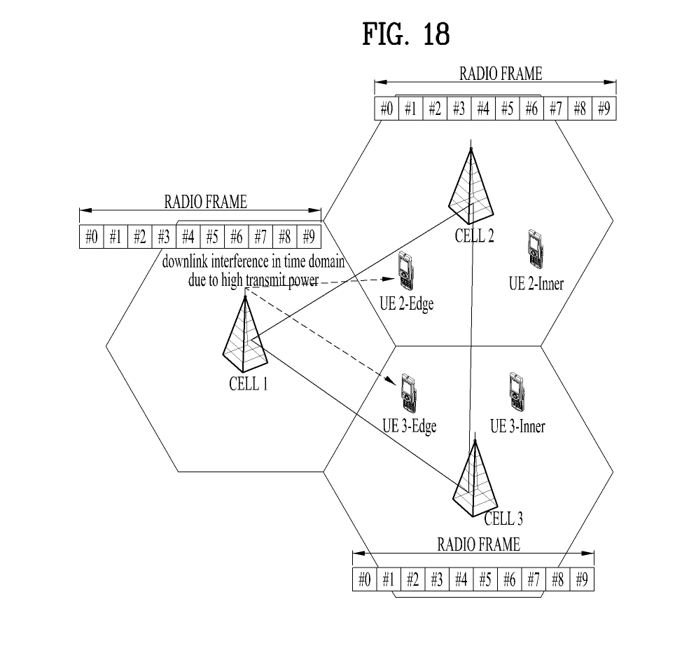

FIG. 18 illustrates an example of applying ICIC in the time domain.

Referring to FIG. 18, each BS configures a specific subframe as a blanking subframe in which no signal is transmitted to eliminate inter-cell interference. That is, BS 1 does not transmit a signal in subframes #1 and #6, BS 2 does not transmit a signal in subframes #2 and #7 and BS 3 does not transmit a signal in subframes #3 and #8. In this case, BS 2 remove interference from BS 1 by allocating a cell-edge UE to subframes #1 or #6 suffering severe interference from BS 1. In the same manner, all BSs can eliminate inter-cell interference by allocation of resources to a specific subframe in the time domain. FIG. 18 illustrates an example and a blanking subframe pattern can be configured in various manners according to system requirements and may be defined as a subframe in which a signal is transmitted with low power instead of a no transmission subframe. 3GPP LTE-A defines a no transmission subframe for interference control in the time domain, which is referred to as an almost blanking subframe (ABS).

Inter-BS ICIC is commonly applicable to a heterogeneous network environment in which BSs in various forms are present as well as the above-described environment including macro BSs. The heterogeneous network environment refers to a system environment in which a pico BS and a femto BS coexist in addition to a macro BS.

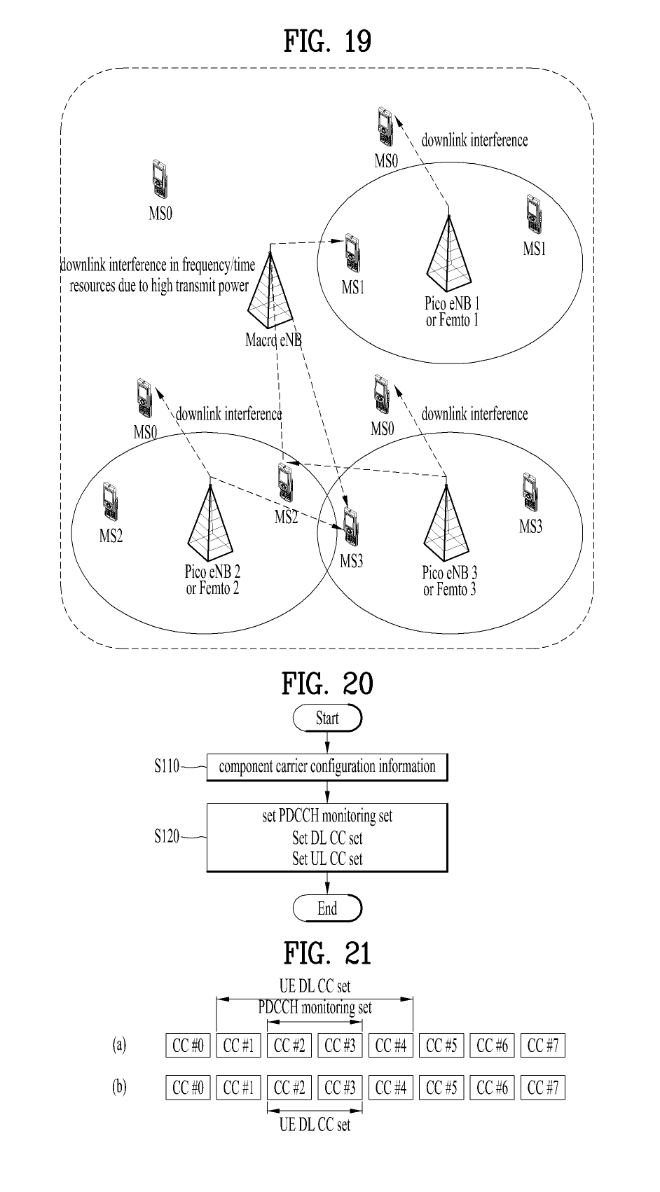

FIG. 19 illustrates an exemplary inter-cell interference situation in a heterogeneous network environment.

Referring to FIG. 19, interference between a macro BS, pico BS and femto BS, interference between pico BSs and between femto BSs are generated in addition to interference between macro BSs. The above-described schemes with respect to ICIC can be equally applied to this situation. Accordingly, the present invention can be applied to a heterogeneous communication system in which BSs in various forms are present through vertical ICIC for controlling interference between BSs in different forms as well as horizontal ICIC for controlling interference between BSs in the same form.

ICIC can be applied to the time domain and frequency domain, as described above. An essential process of ICIC is to determine a transmit power pattern in the time or frequency domain. That is, it is necessary to determine a frequency or time resource region in which a signal is transmitted with high power and a frequency or time resource region in which a signal is transmitted with low power. Transmit power or a no-transmission pattern for interference control can be configured in various manners according to system requirements. A method of predetermining, fixing and operating an interference control resource region and a transmit power pattern between BSs is referred to as static ICIC and a method of varying the interference control resource region and transmit power pattern according to operating environment is referred to as dynamic ICIC. To perform dynamic ICIC, BSs need to exchange information about a transmit power pattern for each resource. In 3GPP LTE, transmit power pattern information with respect to each frequency resource on downlink is exchanged through a relative narrowband transmit power (RNTP) message in the form of a bitmap and transmit power pattern information with respect to each frequency resource on uplink is exchanged through a high interference indicator (HII) message. In the case of uplink, a strongly interfering resource is a resource used by a cell-edge user and thus information about a resource allocated to the cell-edge user is exchanged through an HII message in the form of a bitmap. In 3GPP LTE-A, ABS pattern information in the time domain is exchanged between BSs.

A description will be given of a method for configuring a component carrier set (DL CC set, UL CC set and PDCCH monitoring CC set) and a method for transmitting component carrier configuration information including information about the configured component carrier set, proposed by the present invention.

FIG. 20 is a flowchart illustrating a process of a UE according to an embodiment of the present invention.

Referring to FIG. 20, in a multi-carrier system (or carrier aggregation system), a UE receives component carrier configuration information including component carrier set information from a BS (S110).

The component carrier configuration information includes information about carrier aggregation necessary for the UE. The BS preferably transmits the component carrier configuration information to the UE using higher layer signaling such as RRC (radio resource control) signaling because carrier allocation information can be received with higher reliability through conformation based on HARQ (hybrid automatic repeat request) using higher layer signaling such as RRC signaling, distinguished from L1/L2 control signaling. Furthermore, carrier allocation to a UE need not be dynamically changed for each TTI and a message may be semi-statically transmitted when higher layer signaling is used.

The component carrier set information may be DL CC set information, UL CC set information and PDCCH monitoring CC set information. The component carrier configuration information may further include component carrier type indication information that indicates the type of each component carrier.

The UE can set a DL CC set, a UL CC set and a PDCCH monitoring CC set based on the received component carrier configuration information (S120). Here, the UE can simultaneously performs processes for setting the DL CC set, UL CC set and PDCCH monitoring CC set. When the UE needs to preferentially perform any of these processes, the corresponding process can be preferentially performed.

A description will be given of information (DL CC set information, UL CC set information, PDCCH monitoring CC set information, CC type indication information) included in the component carrier configuration information and a method of representing the information.

The CC type indication information is described first. The CC type indication information indicates the type of each CC included in a CC set.

In LTE-A, component carriers can be categorized into three types.

A first type component carrier is a backward compatible CC supporting backward compatibility for LTE rel-8 UEs. A second type component carrier is a non-backward compatible CC through which LTE UEs cannot access a cell (or BS), that is, a CC supports only LTE-A UEs. A third type component carrier is an extension CC.

The backward compatible CC, the first type component carrier, transmits a reference signal (RS), P-SCH (Primary-Synchronization Channel)/S-SCH (Secondary-Synchronization Channel) and P-BCH (Primary-Broadcast Channel) as well as a PDCCH and a PDSCH according to LTE such that LTE UEs can access a cell (or BS) through the backward compatible CC.

The non-backward compatible CC, the second type component carrier, is transmitted in a modified form such that LTE UEs cannot access a cell (BS) although the PDCCH, PDSCH, RS, P-SCH/S-SCH and PBCH are all transmitted.

The first type component carrier (i.e. backward compatible CC) is a CC through which both LTE UEs and LTE-A UEs can access a cell (or BS) and the second type component carrier (i.e. non-backward compatible CC) is a CC through which only LTE-A UEs can access a cell (or BS). The extension CC, the third type component carrier, is a CC through which a UE cannot access a cell (or BS) and may be an auxiliary component carrier of the first type or second type component carrier. The extension component carrier is not used to transmit a P-SCH/S-SCH, PBCH and PDCCH and all resources of the extension component carrier may be used to transmit a PDSCH of a UE or operate in a slip mode when resources are not scheduled for the PDSCH. A BS or RN does not transmit control information to a UE through the third type component carrier.

That is, the first type component carrier and the second type component carrier can be regarded as a stand alone component carrier that is necessary to form a cell or configures a cell and the third type component carrier can be regarded as a non-stand alone component carrier that needs to be present with one or more stand alone component carriers.

Grant information of a PDSCH and PUSCH transmitted through the third type component carrier can be transmitted through the first type component carrier and the second type component carrier according to cross-carrier scheduling.

A BS can simultaneously transmit the DL CC set information, UL CC set information and CC type indication information to a UE and simultaneously signal the type of each CC include in the DL CC set and the UL CC set to the UE through the component carrier configuration information. The UE can confirm the type of each CC used for carrier aggregation by receiving the CC type indication information.

While the BS can signal the types of CCs included in the DL CC set to an arbitrary UE using UE-specific signaling, the CC types may be set for each UE or commonly set in an arbitrary cell. Accordingly, the BS can signal the types of CCs used in a corresponding cell through cell-specific signaling or cell broadcasting information. This can reduce signaling overhead. Furthermore, the BS can simultaneously signal information about cell specific carrier configuration and the types of cell specific carriers to UEs in the cell.

The method for representing the CC type indication information according to an embodiment of the present invention will now be described.

The number of CC types may be limited. In this case, when the number of predetermined CC types is M, the predetermined CC types can be represented using log₂ M bits. Since log₂ M bits are used to represent a CC type, the BS can signal CC types to a UE using (the number of CCs whose types need to be signaled×log₂ M) bits.

In general, a CC type is cell specific information for the BS or UE. That is, presence or absence of the third type component carrier, first type component carrier and second type component carrier and types thereof can be cell-specifically set. However, carrier indication (CI) for the first type component carrier can be UE-specifically set.

According to an embodiment of the present invention, if a bit width for CI used in release after Rel-10 is set to 3 bits corresponding to a bit width of Rel-10, specific states corresponding to the number of cell-specifically set third type component carriers from among 8 states represented by 3 bits can be reserved and the other states can be used as UE-specific CI values. For example, if the number of third type component carrier is 2, specific states such as 000 and 001 or 110 and 111 can be reserved for the third type component carrier and the other states can be allocated for UE-specific CI.

Alternatively, in order to use the conventional UE-specific CI signaling, CI of the third type component carrier can be set through UE-specific RRC signaling although CI of the third type component carrier is cell-specific CI.

Since the second type component carrier is a CC that can be used only by UEs subsequent to Rel-10 and is initially accessed and scheduled, presence or absence of the second type component carrier or the type thereof may be cell-specifically set. However, CI of the second type component carrier can be UE-specifically set.

FIG. 21(a) illustrates an exemplary PDCCH monitoring set and DL CC set in the multi-carrier system and FIG. 21(b) illustrates an exemplary UL DD set. The multi-carrier system uses 8 carriers. A method for representing DL CC set information will now be described with reference to FIG. 21(a).

As described above, the UE DL CC set refers to a set of DL CCs scheduled for a UE to receive a PDSCH.

The BS can signal the DL CC set information to the UE based on a carrier index. The carrier index is information for representing a carrier. The number of carrier index bits may depend on the number of carriers. That is, the BS can signal the DL CC set information to the UE using (the number of carriers×the number of bits for representing one carrier index) bits.

Referring to FIG. 21(a), since the number of carriers is 8, log₂ 8=3 bits can be used to represent all the carriers. In addition, since the DL CC set includes 4 CCs, the DL CC set can be represented using 4×3=12 bits.

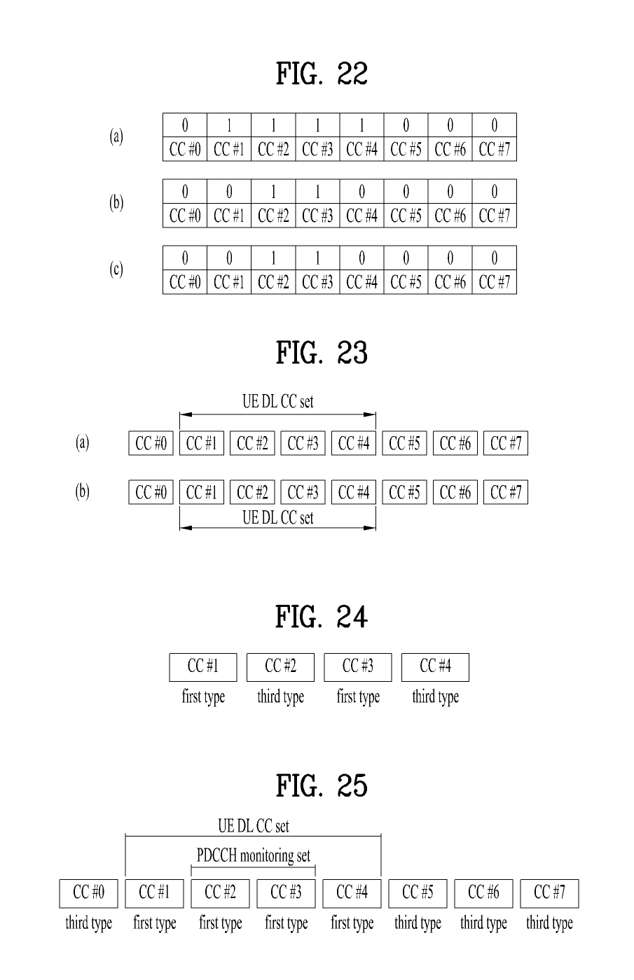

FIG. 22(a) shows a DL CC set represented in the form of a bitmap based on a cell specific carrier configuration. The cell specific carrier configuration includes information about CCs used in the corresponding cell. If the UE knows the information about CCs used in the cell, the BS can generate a bitmap based on the cell specific CCs to signal DL CC set information to the UE.

That is, data can be represented in the bitmap as shown in FIG. 22(a) when the data is based on the DL CC set of the multi-carrier system shown in FIG. 21(a). The BS transmits the DL CC set information to the UE by sending the data to the UE.

Alternatively, the BS can signal the DL CC set information to the UE by generating a bitmap based on activated CCs only while excluding deactivated CCs from the bitmap. The deactivated CCs refer to CCs previously set not to be used during carrier management.

A description will be given of a method for representing UL CC set information with reference to FIG. 21(b).

As described above, the UE UL CC set refers to a set of UL CCs scheduled for a UE to receive a PUSCH.

The BS can signal the UL CC set information to the UE based on a carrier index. The carrier index is information representing a carrier. The number of carrier index bits may depend on the number of carriers. That is, the BS can signal the UL CC set information to the UE by using (the number of carriers×the number of bits for representing one carrier index) bits.

Referring to FIG. 21(b), since the number of carriers is 8, log₂ 8=3 bits can be used to represent all the carriers. In addition, since the UL CC set includes 2 CCs, the UL CC set can be represented using 2×3=6 bits.

FIG. 22(b) shows a UL CC set represented in the form of a bitmap based on a cell specific carrier configuration. The cell specific carrier configuration includes information about CCs used in the corresponding cell. If the UE knows the information about CCs used in the cell, the BS can generate a bitmap based on the cell specific CCs to signal UL CC set information to the UE.

That is, data can be represented in the bitmap as shown in FIG. 22(b) when the data is based on the UL CC set of the multi-carrier system shown in FIG. 21(b). The BS transmits the UL CC set information to the UE by sending the data to the UE.

Alternatively, the BS can signal the UL CC set information to the UE by generating a bitmap based on activated CCs only while excluding deactivated CCs from the bitmap.

The multi-carrier system does not use an unpaired UL CC. The unpaired UL CC refers to a UL CC unlinked to a DL CC. Referring to FIG. 21, CC#0 of FIG. 21(a) is linked to CC#0 of FIG. 21(b). That is, UL CCs and DL CCs are linked and present as pairs in the multi-carrier system. When carrier aggregation is performed, all CCs in a UL CC set may be linked to CCs included in a DL CC set. In this case, the UL CC set can be allocated more efficiently. That is, the BS may not transmit both the DL CC set and the UL CC set and the UE can confirm UL CC set information based on DL CC set information received from the BS. Referring to FIG. 23, a UL CC set includes CC#1, CC#2, CC#3 and CC#4 and a DL CC set includes CC#1, CC#2, CC#3 and C#4. In this case, the UE can confirm UL CC set information based on DL CC set information even if the BS does not transmit the UL CC set information to the UE. Accordingly, efficiency of transmission of information with respect to carrier aggregation.

The UL CC set may be composed of parts of CCs lined to the CCs of the DL CC set. In this case, information representing the UL CC set can be represented based on DL CC set information. Referring to FIG. 21, the DL CC set includes CC#1, CC#2, CC#3 and CC#4. Here, a UL CC set can be represented based on CC#1, CC#2, CC#3 and CC#4 included in the DL CC set. For example, if the UL CC set is represented as a bitmap, it is possible to generate a bitmap based on CC#1, CC#2, CC#3 and CC#4 of the DL CC set rather than generating a bitmap for all CCs of the DL CC set as shown in FIG. 22(b).

A method for representing PDCCH monitoring CC set information will now be described with reference to FIG. 21(a).

As described above, the PDCCH monitoring CC set refers to a set of at least one DL CC performing PDCCH monitoring.

The BS can signal the PDCCH monitoring CC set information to the UE based on a carrier index. The carrier index is information representing a carrier. The number of carrier index bits may depend on the number of carriers. That is, the BS can signal the PDCCH monitoring CC set information to the UE using (the number of carriers×the number of bits for representing one carrier index) bits.

Referring to FIG. 21(a), since the number of carriers is 8, log₂ 8=3 bits can be used to represent all the carriers. In addition, since the PDCCH monitoring CC set includes 2 CCs, the PDCCH monitoring CC set can be represented using 2×3=6 bits.

FIG. 22(c) shows a PDCCH monitoring CC set represented in the form of a bitmap based on a cell specific carrier configuration. The cell specific carrier configuration includes information about CCs used in the corresponding cell. If the UE knows the information about CCs used in the cell, the BS can generate a bitmap based on the cell specific CCs to signal the PDCCH monitoring CC set information to the UE.

That is, data can be represented in the bitmap as shown in FIG. 22(c) when the data is based on the PDCCH monitoring CC set of the multi-carrier system shown in FIG. 21(a). The BS transmits the PDCCH monitoring CC set information to the UE by sending the data to the UE.

The PDCCH monitoring CC set corresponds to the DL CC set or is composed of CCs included in the DL CC set. Accordingly, the PDCCH monitoring CC set can be represented as a bitmap using only as many bits as the number of DL CCs included in the DL CC set in consideration of the above-described characteristic.

Alternatively, the BS can signal the PDCCH monitoring CC set information to the UE by generating a bitmap based on activated CCs only while excluding deactivated CCs from the bitmap.

A description will be given of methods for efficiently representing the DL CC set information, UL CC set information and PDCCH monitoring CC set information when the UE knows CC types.

As described above, the first, second and third type carriers are present. Accordingly, a case in which CCs of different types are contiguous (a case in which the first type CC and the third type CC are contiguous, a case in which the first type CC and the second type CC are contiguous and a case in which the second type CC and the third type CC are contiguous) can be considered. In addition, the characteristics that the third type CC cannot be used alone and omission of a control region can be considered.

When the UE knows the types of CCs included in a CC set, the UE can differently analyze a CC set received from the BS based on the CC types.

FIG. 24 illustrates an exemplary DL CC set that the BS intends to signal to the UE. Referring to FIG. 24, CC#1 and CC#3 correspond to the first type component carrier and CC#2 and CC#4 correspond to the third type component carrier. DL CC set information including CC#1 to CC#4 can be defined in general. However, when the UE knows the CC types, the DL CC set can be differently represented considering that the third type component carrier cannot be used alone. For example, the DL CC set may include only CC#1 and CC#3 and may not include CC#2 and CC#4 corresponding to the third type carrier component. In this case, the UE receives DL CC set information composed of CC#1 and CC#3. CC#2 and CC4 corresponding to the third type carrier component can be analyzed as the DL CC set according to CC#1 and CC#3 linked thereto. On the contrary, only the third type carrier components are designated in the DL CC set and then the first type component carriers linked to the third type component carriers an be added to the DL CC set according to analysis. For example, when the DL CC set information is set, only CC#2 and CC#4 are designated and then CC#1 and CC#3 linked to CC#2 and CC#4 can be included in the DL CC set.

According to an embodiment of the present invention, the PDCCH monitoring CC set information can be efficiently represented using CC types.

FIG. 25 illustrates the component carriers of FIG. 21(a) when CC types are added thereto. As described above, 3 bits are necessary to represent all the CCs. However, if the UE knows CC types, the third type component carrier may be excluded from the CCs, considering that the third type component carrier does not support the control region. Referring to FIG. 25, the CCs include 4 third type component carriers and thus 2 bits are necessary to represent 4 carriers other than the 4 third type component carriers. In this manner, the number of bits necessary to represent the PDCCH monitoring CC set information can be reduced.

Furthermore, the above-described method can be applied to representation of the PDCCH monitoring CC set as a bitmap. Accordingly, the bitmap can be represented based on CC#1, CC#2, CC#3 and CC#4 except for the third type component carriers that do support the control region.

According to an embodiment of the present invention, the DL CC set information or UL CC set information can be confirmed based on a result of monitoring the PDCCH monitoring CC set. When the UE receives the component carrier configuration information from the BS, the UE can preferentially receive the PDCCH monitoring CC set information. The UE can monitor a scheduling PDCCH according to the PDCCH monitoring CC set information and check scheduled CCs. In this case, the UE can use scheduled DL CCs as a DL CC set. In addition, the UE can use scheduled UL CCs as a UL CC set.

Furthermore, since self-scheduling can be set to be performed at all times, DL CCs and/or UL CCs with respect to scheduling CCs may not be separately indicated. In this case, the number of bits used for the scheduled DL CCs and/or UL CCs can be reduced.

According to an embodiment of the present invention, when scheduling information is applied to the third type component carrier, a channel different from the legacy PDCCH monitoring CC set can be configured. In this case, new PDCCH monitoring CC set information can be defined for the third type component carrier. Accordingly, it is possible to define a legacy only PDCCH monitoring CC set, a new scheduling monitoring CC set or a hybrid PDCCH monitoring CC set of the two monitoring CC sets. The legacy only PDCCH monitoring CC set is a monitoring CC set used when scheduling information is not applied to the third type component carrier. The new scheduling monitoring CC set is a monitoring CC set configured in consideration of application of the scheduling information to the third type component carrier. When the third type component carrier is included in the PDCCH monitoring CC set, the UE may need to locate new scheduling monitoring set information.

According to an embodiment of the present invention, the BS can signal CC types to the UE to improve efficiency of an operation of the UE to decode the DL CC set and/or UL CC set. Specifically, when the BS informs the UE of CC type indication information about CCs included in the DL CC set along with the DL CC set information, the UE can perform decoding based on the types of the CCs. That is, when a CC in the DL CC set corresponds to the third type component carrier, the BS can inform the UE that the CC is the third type component carrier such that the UE does not decode a physical channel transmitted in a control region such as a PCFICH, PDCCH or the like without expecting a control region in the CC. Furthermore, the UE can recognize that the control region is not present and perform decoding having information about a shared channel decoding region (position of a PDSCH start symbol). If an arbitrary CC in the DL CC set corresponds to the second type component carrier, the BS can inform the UE that the CC is the second type component carrier such that the UE can perform decoding based on a control channel structure newly defined in the second type component carrier or other new characteristics.

A description will be given of a method for effectively performing inter-cell interference control. A system to which ICIC is applied is assumed in this specification. That is, the method for effectively performing inter-cell interference control is described with reference to the above-described ICIC technology.

According to an embodiment of the present invention, in a heterogeneous communication system, a PSS (Primary Synchronization Signal), SSS (Secondary Synchronization Signal), SI, control signal, etc. are not transmitted through the third type component carrier.

To efficiently manage component carriers, the component carriers can be categorized according to roles and characteristics thereof. The component carriers can be classified into a primary component carrier (PCC) and a secondary component carrier (SCC). The PCC is a central component carrier in component carrier management when a plurality of component carriers is used and can be defined for each UE. Component carriers other than the PCC can be defined as SCCs.

Accordingly, for inter-cell interference control, a macro PCC and a pico third type component carrier can be coordinated such that they correspond to the same frequency. In this case, the PCC includes control information and the third type component carrier does not include information about a control region, in general. Therefore, interference can be reduced using the above-described characteristics. Furthermore, a macro third type component carrier and a pico PCC can be coordinated such that they correspond to the same frequency.

1. A method for allocating component carriers in a carrier aggregation system, comprising:
receiving, from a base station, component carrier configuration information about a plurality of component carriers supported by the base station,
wherein the component carrier configuration information includes at least one piece of component carrier set information,
wherein the component carrier set information is downlink component carrier set information regarding downlink component carriers through which a physical downlink shared channel (PDSCH) is transmitted, uplink component carrier set information regarding uplink component carriers through which a physical uplink shared channel (PUSCH) is transmitted, or PDCCH monitoring component carrier set information regarding PDCCH monitoring component carriers through which a physical downlink control channel (PDCCH) is transmitted.

2. The method according to claim 1, wherein the component carrier configuration information includes component carrier type indication information indicating the type of each component carrier in the component carrier set.

3. The method according to claim 1, wherein the component carrier set information is configured with indices indicating component carriers in the component carrier set or configured in the form of a bitmap.

4. The method according to claim 1, wherein the component carrier configuration information is configured UE-specifically or cell-specifically.

5. The method according to claim 1, further comprising monitoring a plurality of PDCCHs through PDCCH monitoring component carriers based on the component carrier configuration information.

6. The method according to claim 2, wherein the component carrier type is a first type component carrier corresponding to a backward compatible component carrier, a second type component carrier corresponding to a non-backward compatible component carrier or a third type component carrier corresponding to an extension component carrier.

7. The method according to claim 1, wherein the component carrier configuration information is transmitted from the base station through RRC signaling.

8. The method according to claim 6, wherein the downlink component carrier set information includes the third type component carrier, the third type component carrier being linked to a first type component carrier or a second type component carrier in the downlink component carrier set.

9. The method according to claim 6, wherein the uplink component carrier set information includes the third type component carrier, the third type component carrier being linked to a first type component carrier or a second type component carrier in the uplink component carrier set.

10. The method according to claim 3, wherein the bitmap is configured for activated component carriers.

11. A UE for component carrier allocation in a carrier aggregation system, comprising:
an RF communication unit for transmitting/receiving an RF signal; and
a controller connected to the RF communication unit,
wherein the controller controls the RF communication unit to receive, from a base station, component carrier configuration information about a plurality of component carriers supported by the base station,
wherein the component carrier configuration information includes at least one piece of component carrier set information,
wherein the component carrier set information is downlink component carrier set information regarding downlink component carriers through which a physical downlink shared channel (PDSCH) is transmitted, uplink component carrier set information regarding uplink component carriers through which a physical uplink shared channel (PUSCH) is transmitted, or PDCCH monitoring component carrier set information regarding PDCCH monitoring component carriers through which a physical downlink control channel (PDCCH) is transmitted.

12. The UE according to claim 11, wherein the component carrier configuration information includes component carrier type indication information indicating the type of each component carrier in the component carrier set.

13. The UE according to claim 11, wherein the component carrier set information is configured with indices indicating component carriers in the component carrier set or configured in the form of a bitmap.

14. The UE according to claim 11, wherein the component carrier configuration information is configured UE-specifically or cell-specifically.

15. The UE according to claim 11, wherein the controller monitors a plurality of PDCCHs through PDCCH monitoring component carriers based on the component carrier configuration information.

16. The UE according to claim 12, wherein the component carrier type is a first type component carrier corresponding to a backward compatible component carrier, a second type component carrier corresponding to a non-backward compatible component carrier or a third type component carrier corresponding to an extension component carrier.
